(19) United States
(12) Patent Application Publication
(10) Pub. No.: US 2015/0163285 A1
(43) Pub. Date: Jun. 11, 2015

(54) Identifying The Workload Of A Hybrid Cloud Based On Workload Provisioning Delay

(71) Applicant: International Business Machines Corporation, Armonk, NY (US)

(72) Inventors: Al Chakra, Apex, NC (US); Glenn P. Crawford, Cary, NC (US); Rahul Ghosh, Durham, NC (US); Rocky D. McMahan, Raleigh, NC (US)

(73) Assignee: International Business Machines Corporation, Armonk, NY (US)

(21) Appl. No.: 14/103,606

(22) Filed: Dec. 11, 2013

(51) Int. Cl. H04L 29/08

(52) U.S. Cl. CPC H04L 67/10

(57) ABSTRACT

An approach is provided for an information handling system to select a cloud environment for a workload. In the approach a number of provisioning delays are identified with each of the provisioning delays corresponding to the workload being provisioned at a different cloud-based environment. One of the cloud-based environments is selected, with the selected cloud-based environment being based on the provisioning delay that was identified to provision the workload at the selected cloud-based environment. The workload is then deployed at the selected cloud-based environment.

### BACKGROUND OF THE INVENTION

Cloud computing relates to concepts that utilize large numbers of computers connected through a computer network, such as the Internet. Cloud based computing refers to network-based services. These services appear to be provided by server hardware. However, the services are instead served by virtual hardware (virtual machines, or “VMs”), that are simulated by software running on one or more real computer systems. Because virtual servers do not physically exist, they can therefore be moved around and scaled “up” or “out” on the fly without affecting the end user. Scaling “up” (or “down”) refers to the addition (or reduction) of resources (CPU, memory, etc.) to the VM performing the work. Scaling “out” (or “in”) refers to adding, or subtracting, the number of VMs assigned to perform a particular workload. Cloud provisioning focuses on the deployment of an organization's cloud computing strategy. The organization might first select those applications and services will reside in a public cloud and which will remain on site behind the firewall or in a private cloud. Cloud provisioning also entails developing the processes for interfacing with the cloud's applications and services as well as auditing and monitoring who accesses and utilizes the resources. Hybrid cloud computing involves the use of two or more clouds (private or public) that remain unique entities but are bound together, offering the benefits of multiple deployment models. Hybrid clouds allow organizations to extend either the capacity or the capability of a cloud service, by aggregation, integration or customization, with another cloud service.

### SUMMARY

An approach is provided for an information handling system to select a cloud environment for a workload. In the approach a number of provisioning delays are identified with each of the provisioning delays corresponding to the workload being provisioned at a different cloud-based environment. One of the cloud-based environments is selected, with the selected cloud-based environment being based on the provisioning delay that was identified to provision the workload at the selected cloud-based environment. The workload is then deployed at the selected cloud-based environment.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a component diagram depicting components utilized in identifying the workload of a hybrid cloud based on its provisioning delay;

FIG. 4 is a depiction of a flowchart showing the logic performed by the hybrid cloud workload selector;

FIG. 5 is a depiction of a flowchart showing the logic used to select a cloud based on preferences and provisioning scores;

FIG. 6 is a depiction of a flowchart showing the logic performed to deploy a workload and monitor its provisioning delay; and

FIG. 7 is a depiction of a flowchart showing the logic performed to generate a provisioning delay score.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

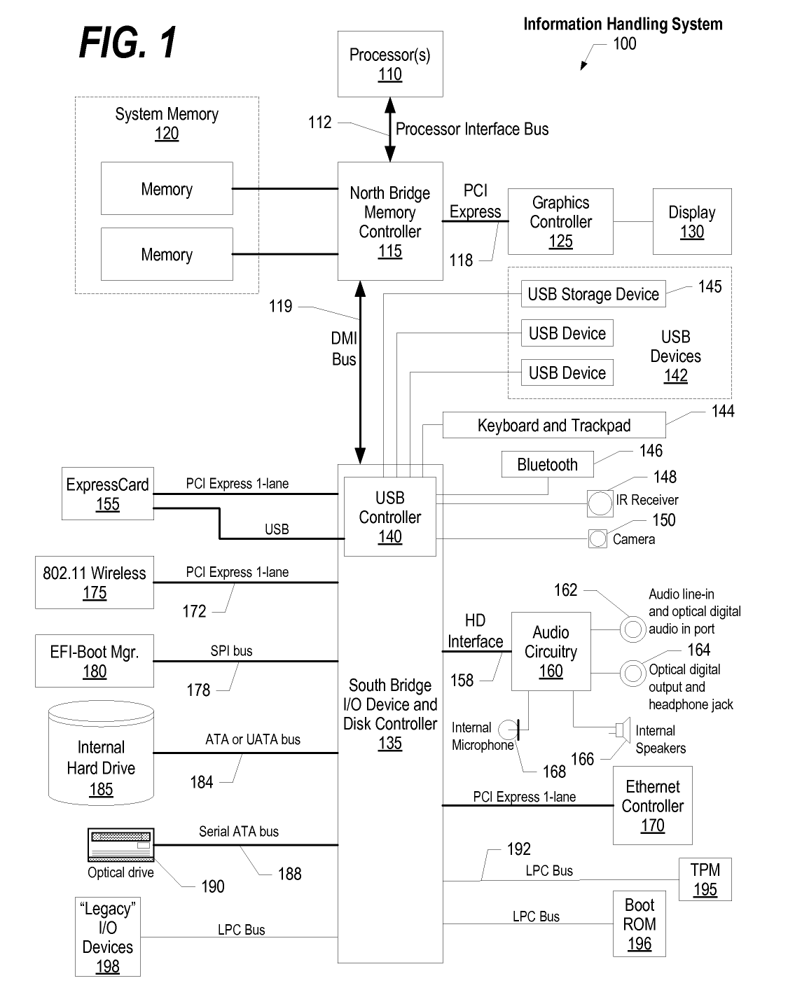

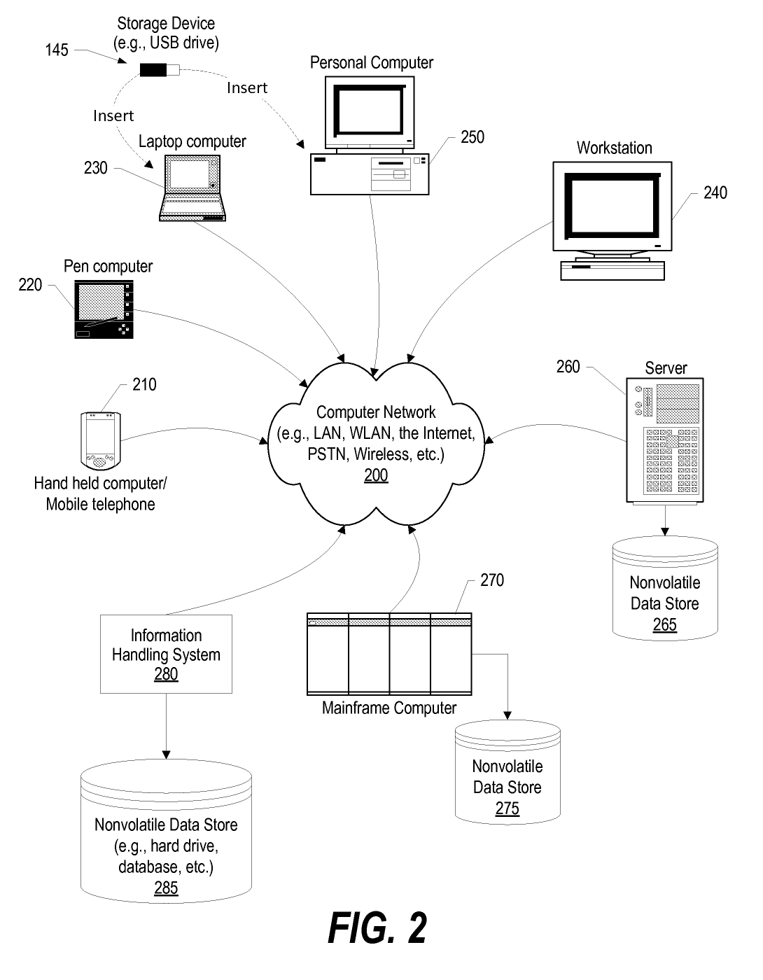

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

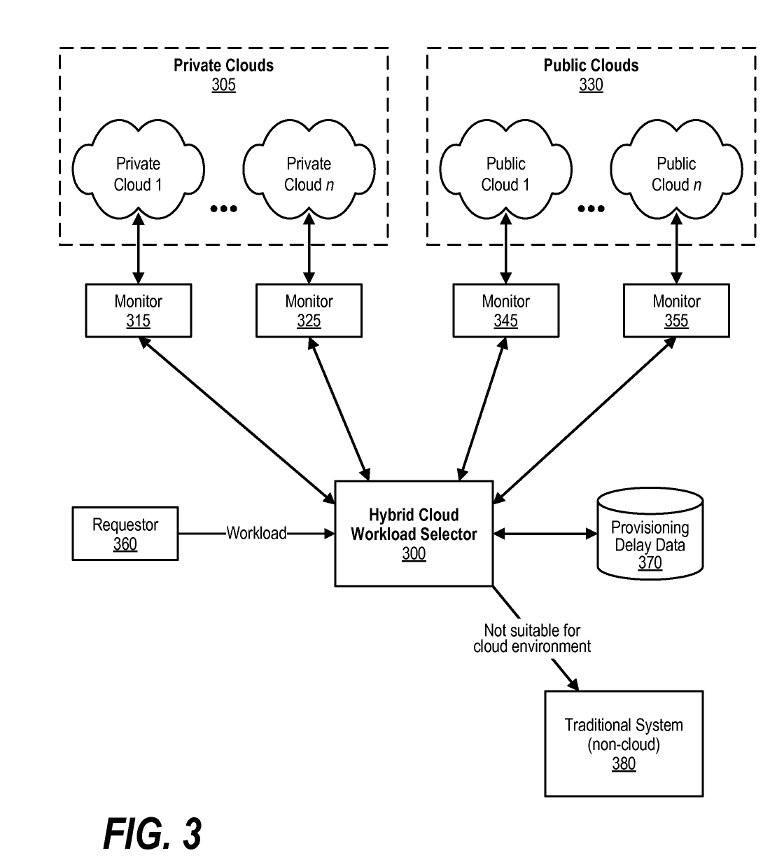

FIGS. 3-7 depict an approach that can be executed on an information handling system, to select a cloud-based environment for deployment of a workload. In the approach a number of provisioning delays are identified with each of the provisioning delays corresponding to the workload being provisioned at a different cloud-based environment. One of the cloud-based environments is selected, with the selected cloud-based environment being based on the provisioning delay that was identified to provision the workload at the selected cloud-based environment. The workload is then deployed at the selected cloud-based environment. To generate the provisioning delay, a number of factors are analyzed. These factors include a cloud health factor, a placement logic factor, a geographic cloud data center factor, a current cloud metrics factor, a workload-based resource metric factor, and a historical provisioning delay factor. A different weighting value is applied to the various factors. The weighting values are multiplied by a factor value corresponding to the respective factor. A preferred type of cloud-based environment is identified for to the workload with the cloud type being either a public cloud-based environment and a private cloud-based environment. The selected cloud-based environment is also based on the identified preferred type of cloud-based environment. In one embodiment, if a public cloud-based environment is preferred and any of the available public cloud-based environments satisfy a provisioning threshold, then the workload is provisioned on one of the public cloud-based environments that satisfy the threshold, otherwise a private cloud-based environment that satisfies the threshold is chosen. Likewise, if a private cloud-based environment is preferred and any of the available private cloud-based environments satisfy a provisioning threshold, then the workload is provisioned on one of the private cloud-based environments that satisfy the threshold, otherwise a public cloud-based environment that satisfies the threshold is chosen. If none of the cloud-based environments satisfy the threshold, then a non-cloud-based environment, is chosen and the workload is provisioned on a traditional computer system.

FIG. 3 is a component diagram depicting components utilized in identifying the workload of a hybrid cloud based on its provisioning delay. The hybrid cloud-based environment includes both private cloud-based environments 305 as well as public cloud-based environments 330. There can be any number of private cloud-based environments and public cloud-based environments. As shown, the various cloud-based environments are monitored using either internal monitoring within the individual clouds, using external monitoring techniques, or a combination of both. In the example shown, monitors 315, 325, 345, and 355 are shown monitoring various cloud-based environments with monitors 315 and 325 monitoring private cloud-based environments 305 and monitors 345 and 355 monitoring public cloud-based environments 330.

The data gathered by the various monitors is used by hybrid cloud workload selector 300 to identify a cloud-based environment that is suitable for a workload that is being requested by requestor 360. The historical data gathered when provisioning workloads is stored in provisioning delay data store 370. Hybrid cloud workload selector attempts to select one of the available cloud-based environments based on a number of factors. However, if the requested workload is not suitable for a cloud-based environment, then hybrid cloud workload selector will provision, or recommend provisioning, the workload on traditional system 380 with the traditional system being a computer system that is not a cloud-based environment.

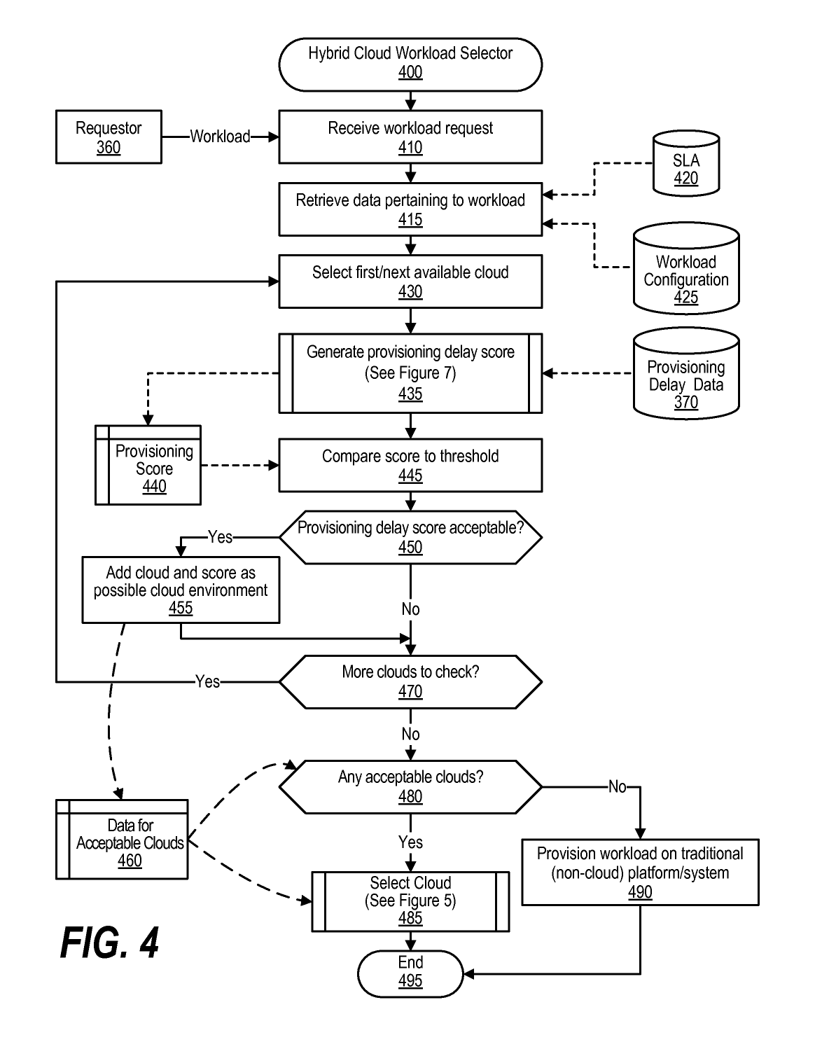

FIG. 4 is a depiction of a flowchart showing the logic performed by the hybrid cloud workload selector. Processing commences at 400 whereupon, at step 410, the process receives a workload request to provision a workload with the workload request being received from requestor 360. At step 415, the process retrieves data that pertains to the workload. The data pertaining to the workload is retrieved from a Service Level Agreement (SLA) stored in data store 420 that details the level of service contracted for by the customer. In addition, data pertaining to the workload is retrieved from a workload configuration that is stored in data store 425. The workload configuration includes metadata regarding the workload, such as the sensitivity of the workload and whether a private or public cloud-based environment is preferred when deploying the workload to a cloud-based environment.

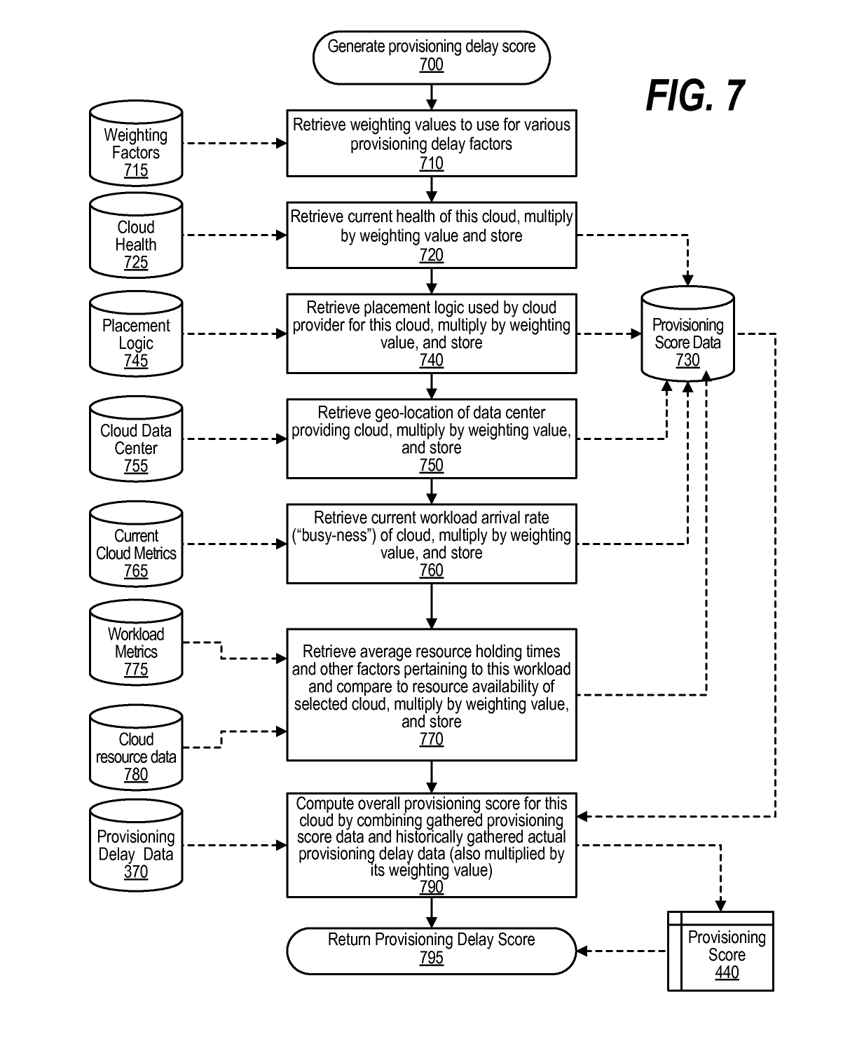

At step 430, the process selects the first available cloud-based environment from a list of available cloud-based environments. Some of the available cloud-based environments might be public cloud-based environments, while others might be private cloud-based environments. At predefined process 435, the process identifies a provisioning delay corresponding to the workload being provisioned at the selected cloud-based environment (see FIG. 7 and corresponding text for processing details). In one embodiment, the identified provisioning delay is captured in terms of a provisioning delay score that the process generates by analyzing a variety of factors pertaining to the selected cloud-based environment. The factors used can include factors such as cloud a health factor, a placement logic factor, a geographic cloud data center factor, a current cloud metrics factor, a workload-based resource metric factor, and a historical provisioning delay factor. The provisioning score is stored by predefined process into memory area 440. At step 445, the provisioning score that was generated for the selected cloud-based environment is compared to a threshold. A decision is then made by the process as to whether the provisioning delay is acceptable (decision 450). If the provisioning delay, as reflected by the score, is acceptable, then d 450 branches to the “yes” branch whereupon, at step 455, the process adds the selected cloud-based environment and the provisioning score as a possible cloud-based environment for the workload. The data for the selected cloud-based environment and its provisioning score is stored in memory area 460. Returning to decision 450, if the provisioning delay for the selected cloud-based environment is unacceptable, then decision 450 branches to the “no” branch bypassing step 455.

A decision is made by the process as to whether there are more cloud-based environments to process to see if they are acceptable candidates for deploying the workload (decision 470). If there are more cloud-based environments to process, then decision 470 branches to the “yes” branch which loops back to select and process the next cloud-based environment as discussed above. This looping continues until all of the cloud-based environments have been processed, at which point decision 470 branches to the “no” branch.

A decision is made by the process as to whether any of the cloud-based environments were found to be acceptable candidates for deployment of the workload (decision 480). If one or more of the cloud-based environments was found to be acceptable (with data being stored in memory area 460), then decision 480 branches to the “yes” branch whereupon, at predefined process 485, the process selects one of the cloud-based environments from the list of cloud-based environments included in memory area 460. On the other hand, if none of the cloud-based environments was found to be an acceptable environment for the workload, then decision 480 branches to the “no” branch whereupon, at step 490, the process provisions the workload on a traditional computer system that is not a cloud-based environment. Processing performed by the Hybrid Cloud Workload Selector thereafter ends at 495.

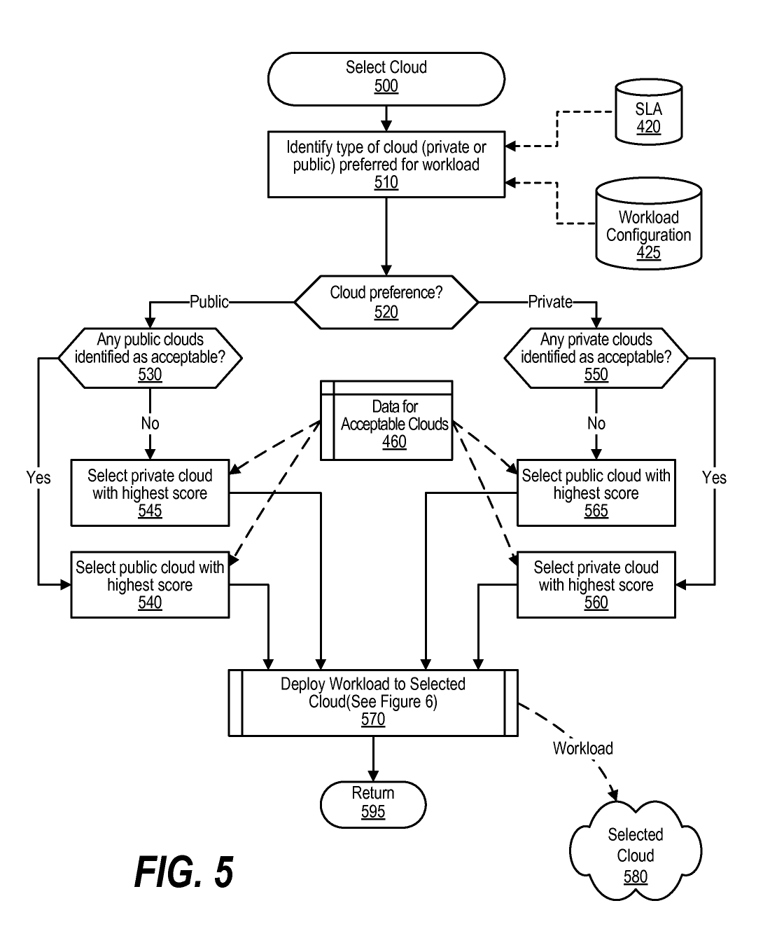

FIG. 5 is a depiction of a flowchart showing the logic used to select a cloud based on preferences and provisioning scores. The cloud selection process commences at 500 whereupon, at step 510, the process identifies a preferred type of cloud-based environment that corresponds to the workload. In one embodiment, the identification of the preferred type of cloud-based environment is based on data retrieved from Service Level Agreement (SLA) that pertains to the customer of the workload which is retrieved from data store 420, as well as a workload configuration that is retrieved from data store 425. The SLA may indicate an overall preference that the customer has when deploying workloads, with the overall preference being cost-related, sensitivity-related, or related to some other interest of the customer. The workload configuration includes metadata about the workload that is being deployed and may indicate whether the workload is sensitive or some other characteristics of the workload as well as an indicated preference as to whether the workload should be deployed on a private or public cloud-based environment.

A decision is made by the process as to whether the preferred type of cloud-based environment for workload is private or public (decision 520). If the preferred type of cloud-based environment for workload is a public cloud-based environment, then decision 520 branches to the “public” branch whereupon a decision is made by the process as to whether any public cloud-based environments were identified as being acceptable in terms of their provisioning delays for the workload (decision 530). If any of the public cloud-based environments were found to be acceptable, then decision 530 branches to the “yes” branch whereupon, at step 540, the public cloud-based environment that has the highest (best) provisioning score (e.g., lowest provisioning delay, etc.) is selected. On the other hand, if none of the public cloud-based environments were found to be acceptable, then decision 530 branches to the “no” branch whereupon, at step 545, the private cloud-based environment that has the highest (best) provisioning score (e.g., lowest provisioning delay, etc.) is selected.

Returning to decision 520, if the preferred type of cloud-based environment for workload is a private cloud-based environment, then decision 520 branches to the “private” branch whereupon a decision is made by the process as to whether any private cloud-based environments were identified as being acceptable in terms of their provisioning delays for the workload (decision 550). If any of the private cloud-based environments were found to be acceptable, then decision 550 branches to the “yes” branch whereupon, at step 560, the private cloud-based environment that has the highest (best) provisioning score (e.g., lowest provisioning delay, etc.) is selected. On the other hand, if none of the private cloud-based environments were found to be acceptable, then decision 550 branches to the “no” branch whereupon, at step 565, the public cloud-based environment that has the highest (best) provisioning score (e.g., lowest provisioning delay, etc.) is selected. Of course, if the client's preference regarding a type of cloud-based environment prohibits a particular type of cloud from being used to deploy the workload, then the workload can be deployed on a traditional, non-cloud based, computer system.

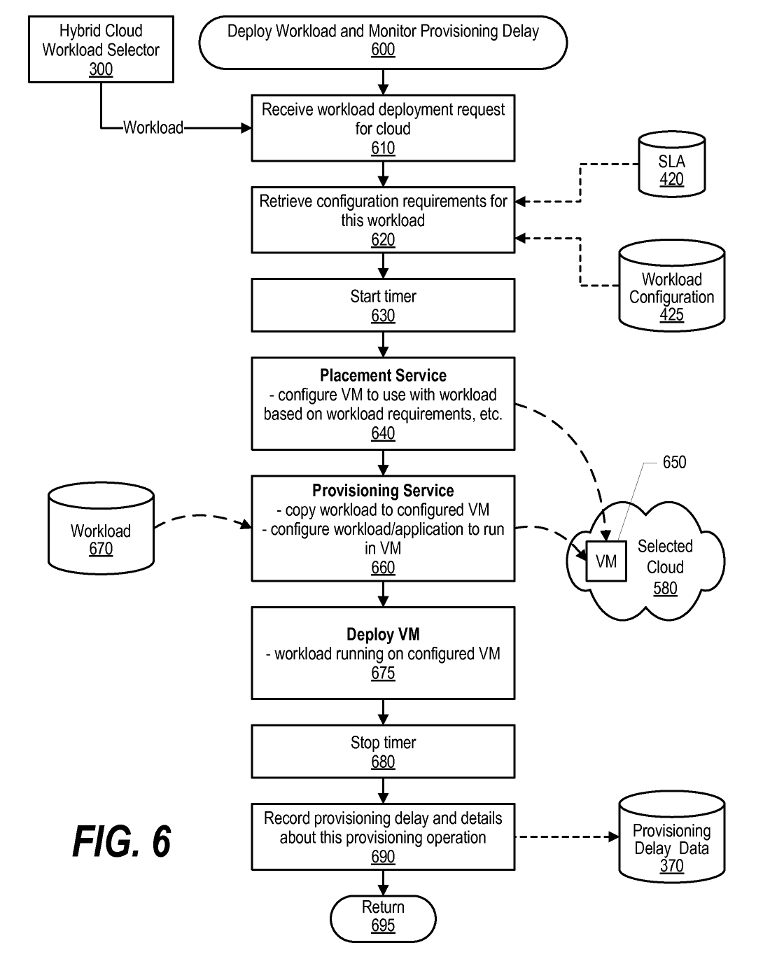

At predefined process 570, the process deploys the workload to the public, or private, cloud 580 that was selected by the steps described above (see FIG. 6 and corresponding text for processing details). Processing then returns to the calling routine (see FIG. 4) at 595.

FIG. 6 is a depiction of a flowchart showing the logic performed to deploy a workload and monitor its provisioning delay. Deployment processing commences at 600 whereupon, at step 610, the process receives a deployment request from Hybrid Cloud Workload Selector 300, to deploy the workload to a particular private or public cloud-based environment. At step 620, the deployment process retrieves configuration requirements needed to deploy the workload. The deployment requirements may be gathered from the customer's SLA which is retrieved from data store 420 as well as from this particular workload's configuration settings which are shown being retrieved from data store 425.

At step 630, the deployment process starts a timer. At step 640, the deployment process performs a placement service at selected cloud-based environment 580. The placement service configures at least one virtual machine (VM 650) running in the selected cloud-based environment. The VM that is configured is used to run the workload and the configuration is performed based on workload requirements and other configuration requirements that were retrieved at step 620.

After the VM that will be used to run the workload is placed in the selected cloud-based environment, at step 660, the process performs a provisioning service that provisions the workload, retrieved from data store 670, to the configured VM. During the provisioning process, the workload is copied to the configured VM and, once copied to the VM, the workload, such as an application, is configured to run in the VM by configuring various workload and VM configuration settings. After the placement service and the provisioning service have been performed, at step 675, the VM is deployed with the configured workload now running on the configured VM. Once the VM is deployed, at step 680, the timer is stopped.

At step 690, the total provisioning delay (time between the timer being started and stopped) is recorded in data store 370. In addition, at step 690 additional details about the provisioning operation, including details about the performance of the placement service and the provisioning service, are also recorded in data store 370. Processing thereafter returns to the calling routine (see FIG. 5) at 695.

FIG. 7 is a depiction of a flowchart showing the logic performed to generate a provisioning delay score. The process that generates the provisioning delay score commences at 700 whereupon, at step 710, the process retrieves weighting values that are used for various provisioning delay factors that are processed in steps 720, 740, 750, 760, 770, and 790. The weighting values are retrieved from data store 715.

At step 720, the process retrieves the current health of this cloud (a value) from data store 725. The current health value is multiplied by the weighting value used for the current health value and the resulting value is stored in data store 730. Data store 730 is a data store used to store provisioning score data resulting from steps 720, 740, 750, 760, and 770.

At step 740, the process retrieves the placement logic used by cloud provider for this cloud (a value) from data store 745. The placement logic value is multiplied by the weighting value used for the placement logic value and the resulting value is stored in data store 730.

At step 750, the process retrieves the geo-location of data center providing cloud (a value) from data store 755. The geo-location of data center providing cloud value is multiplied by the weighting value used for the geo-location of data center providing cloud value and the resulting value is stored in data store 730.

At step 760, the process retrieves the current workload arrival rate (“busy-ness”) of cloud (the “busy-ness” value) from data store 765. The “busy-ness” value is multiplied by the weighting value used for the “busy-ness” value and the resulting value is stored in data store 730.

At step 770, the process retrieves the average resource holding times and other factors pertaining to this workload from workload metrics data store 775. The average resource holding times and other factors pertaining to this workload are compared to the resource availability provided by the selected cloud. The resource availability provided by the selected cloud is retrieved from cloud resource data store 780. The comparison is used to calculate a value that is multiplied by the weighting value used for the resource holding and availability value and the resulting value is stored in data store 730.

At step 790, the process computes an overall provisioning score for this cloud-based environment by combining the gathered provisioning score data from data store 730 as well as the historically gathered actual provisioning delay data from data store 370. The historically gathered actual provisioning delay data is used to calculate a provisioning delay score that is multiplied by its weighting value. The overall provisioning score for this cloud-based environment is stored in memory area 440. Memory area 440 is used to store overall provisioning scores for all of the cloud-based environments that are analyzed. As shown in FIG. 4, these overall provisioning scores are used to weed out unacceptable cloud-based environments as well as help in the selection of the cloud-based environment that will be used to deploy the workload. Processing returns to the calling routine (see FIG. 4) at 795.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, in an information handling system comprising a processor and a memory, of selecting a cloud environment for a workload, the method comprising:
identifying a plurality of provisioning delays corresponding to the workload, wherein each of the provisioning delays corresponds to provisioning the workload at one of the plurality of cloud-based environments;
selecting one of the plurality of cloud-based environments, wherein the selecting is based on the provisioning delay identified to provision the workload at the selected cloud-based environment; and
deploying the workload at the selected cloud-based environment.

2. The method of claim 1 wherein the identification of the provisioning delays further comprises:
analyzing one or more factors of each of the cloud-based environments, wherein one or more of the factors are selected from the group consisting of a cloud health factor, a placement logic factor, a geographic cloud data center factor, a current cloud metrics factor, a workload-based resource metric factor, and a historical provisioning delay factor.

3. The method of claim 2 further comprising:
applying a different weighting value corresponding to one or more of the factors, wherein each of the weighting values is multiplied by a factor value corresponding to the respective factor.

4. The method of claim 2 further comprising:
identifying a preferred type of cloud-based environment corresponding to the workload, wherein the preferred type of cloud-based environment is selected from the group consisting of a public cloud-based environment and a private cloud-based environment, and wherein the selecting one of the plurality of cloud-based environments is also based on the identified preferred type of cloud based environment.

5. The method of claim 4 further comprising:
comparing each of the plurality of provisioning delays to a threshold; and
in response to the preferred type of cloud-based environment being the public cloud-based environment:
selecting one of the public cloud-based environments in response to the selected cloud-based environment being a public cloud-based environment and satisfying the threshold; and
selecting one of the private cloud-based environments in response to none of the public cloud-based environments satisfying the threshold and the selected one of the private cloud-based environments satisfying the threshold; and
in response to the preferred type of cloud-based environment being the private cloud-based environment:
selecting one of the private cloud-based environments in response to the selected cloud-based environment being a private cloud-based environment and satisfying the threshold; and
selecting one of the public cloud-based environments in response to none of the private cloud-based environments satisfying the threshold and the selected one of the public cloud-based environments satisfying the threshold.

6. The method of claim 5 further comprising:
in response to none of the cloud-based environments satisfying the threshold:
provisioning the workload on a traditional non-cloud based computer system.

7. The method of claim 4 further comprising:
retrieving data pertaining to the workload, wherein the retrieved data includes a Service Level Agreement (SLA) data and a workload configuration, wherein the identified preferred type of cloud-based environment corresponding to the workload is based on the retrieved data.

8. An information handling system comprising:
one or more processors;
a memory coupled to at least one of the processors; and
a set of instructions stored in the memory and executed by at least one of the processors to selecting a cloud environment for a workload, wherein the set of instructions perform actions of:
identifying a plurality of provisioning delays corresponding to the workload, wherein each of the provisioning delays corresponds to provisioning the workload at one of the plurality of cloud-based environments;
selecting one of the plurality of cloud-based environments, wherein the selecting is based on the provisioning delay identified to provision the workload at the selected cloud-based environment; and
deploying the workload at the selected cloud-based environment.

9. The information handling system of claim 8 wherein the identification of the provisioning delays further comprises:
analyzing one or more factors of each of the cloud-based environments, wherein one or more of the factors are selected from the group consisting of a cloud health factor, a placement logic factor, a geographic cloud data center factor, a current cloud metrics factor, a workload-based resource metric factor, and a historical provisioning delay factor.

10. The information handling system of claim 9 wherein the actions further comprise:
applying a different weighting value corresponding to one or more of the factors, wherein each of the weighting values is multiplied by a factor value corresponding to the respective factor.

11. The information handling system of claim 9 wherein the actions further comprise:
identifying a preferred type of cloud-based environment corresponding to the workload, wherein the preferred type of cloud-based environment is selected from the group consisting of a public cloud-based environment and a private cloud-based environment, and wherein the selecting one of the plurality of cloud-based environments is also based on the identified preferred type of cloud based environment.

12. The information handling system of claim 11 wherein the actions further comprise:
comparing each of the plurality of provisioning delays to a threshold; and
in response to the preferred type of cloud-based environment being the public cloud-based environment:
selecting one of the public cloud-based environments in response to the selected cloud-based environment being a public cloud-based environment and satisfying the threshold; and
selecting one of the private cloud-based environments in response to none of the public cloud-based environments satisfying the threshold and the selected one of the private cloud-based environments satisfying the threshold; and
in response to the preferred type of cloud-based environment being the private cloud-based environment:
selecting one of the private cloud-based environments in response to the selected cloud-based environment being a private cloud-based environment and satisfying the threshold; and
selecting one of the public cloud-based environments in response to none of the private cloud-based environments satisfying the threshold and the selected one of the public cloud-based environments satisfying the threshold.

13. The information handling system of claim 12 wherein the actions further comprise:
in response to none of the cloud-based environments satisfying the threshold:
provisioning the workload on a traditional non-cloud based computer system.

14. The information handling system of claim 11 wherein the actions further comprise:
retrieving data pertaining to the workload, wherein the retrieved data includes a Service Level Agreement (SLA) data and a workload configuration, wherein the identified preferred type of cloud-based environment corresponding to the workload is based on the retrieved data.

15. A computer program product stored in a computer readable medium, comprising computer instructions that, when executed by an information handling system, causes the information handling system to select a cloud environment for a workload by performing actions comprising:
identifying a plurality of provisioning delays corresponding to the workload, wherein each of the provisioning delays corresponds to provisioning the workload at one of the plurality of cloud-based environments;
selecting one of the plurality of cloud-based environments, wherein the selecting is based on the provisioning delay identified to provision the workload at the selected cloud-based environment; and
deploying the workload at the selected cloud-based environment.

16. The computer program product of claim 15 wherein the identification of the provisioning delays further comprises:
analyzing one or more factors of each of the cloud-based environments, wherein one or more of the factors are selected from the group consisting of a cloud health factor, a placement logic factor, a geographic cloud data center factor, a current cloud metrics factor, a workload-based resource metric factor, and a historical provisioning delay factor.

17. The computer program product of claim 16 wherein the actions further comprise:
applying a different weighting value corresponding to one or more of the factors, wherein each of the weighting values is multiplied by a factor value corresponding to the respective factor.

18. The computer program product of claim 16 wherein the actions further comprise:
identifying a preferred type of cloud-based environment corresponding to the workload, wherein the preferred type of cloud-based environment is selected from the group consisting of a public cloud-based environment and a private cloud-based environment, and wherein the selecting one of the plurality of cloud-based environments is also based on the identified preferred type of cloud based environment.

19. The computer program product of claim 18 wherein the actions further comprise:
comparing each of the plurality of provisioning delays to a threshold; and
in response to the preferred type of cloud-based environment being the public cloud-based environment:
selecting one of the public cloud-based environments in response to the selected cloud-based environment being a public cloud-based environment and satisfying the threshold; and
selecting one of the private cloud-based environments in response to none of the public cloud-based environments satisfying the threshold and the selected one of the private cloud-based environments satisfying the threshold;
in response to the preferred type of cloud-based environment being the private cloud-based environment:
selecting one of the private cloud-based environments in response to the selected cloud-based environment being a private cloud-based environment and satisfying the threshold; and
selecting one of the public cloud-based environments in response to none of the private cloud-based environments satisfying the threshold and the selected one of the public cloud-based environments satisfying the threshold; and
in response to none of the cloud-based environments satisfying the threshold:
provisioning the workload on a traditional non-cloud based computer system.

20. The computer program product of claim 18 wherein the actions further comprise:
retrieving data pertaining to the workload, wherein the retrieved data includes a Service Level Agreement (SLA) data and a workload configuration, wherein the identified preferred type of cloud-based environment corresponding to the workload is based on the retrieve data.
